(19) United States
(12) Patent Application Publication
(10) Pub. No.: US 2005/0068259 A1
(43) Pub. Date: Mar. 31, 2005

(54) Method for driving a plasma display with matrix triggering in stages

(76) Inventors: Ana Lacoste, St. Martin le Vinoux (FR); Dominique Gagnot, Charavines (FR); Pascal Denoyelle, Meylan (FR)

Correspondence Address: PATENT OPERATIONS;THOMSON LICENSING INC., PO BOX 5312, PRINCETON, NJ, 08543-5312, US

(21) Appl. No.: 10/883,543

(22) Filed: Jul. 1, 2004

(30) Foreign Application Priority Data
Jul. 3, 2003 (FR) 0308084

(51) Int. Cl. G09G 3/28

(52) U.S. Cl. 345/60

(57) ABSTRACT

Method comprising a succession of image frames which each comprise a sustain phase of the display discharge regions which itself comprises the application of sustain voltage pulses V_{S} between the electrodes of each pair crossing these regions, and, during each sustain pulse, the application of trigger voltage pulses V_{M} to groups of discharge regions, which pulses are applied successively and not simultaneously to the various groups of discharge regions. Thanks to the application in stages of the trigger pulses during each sustain pulse, a reduction in the instantaneous current required to supply the display is obtained.

### 1/ BACKGROUND OF THE INVENTION

The invention relates to a method for driving a plasma screen for displaying images comprising discharge regions each positioned at an intersection of a pair of coplanar sustain electrodes and an address electrode, the said method comprising a succession of image frames or subframes which each comprise a reset phase, an address phase for selectively activating display discharge regions and a sustain phase for the discharge regions, the said sustain phase comprising:
the application of sustain voltage pulses between the electrodes of each pair designed to initiate, under the effect of a trigger pulse, plasma discharges between these electrodes solely in the regions with pre-activated discharges,
in synchronization with these sustain pulses, the application of trigger voltage pulses, designed to trigger these discharges, between one of the electrodes of each pair and the address electrodes.

### 2/ PRIOR ART

Document US 2002/0030645 describes such a method applied to an AC plasma display with memory effect comprising two plane panels, one front and one rear, enclosing between them a space filled with discharge gas which is partitioned into discharge regions, notably by means of barrier ribs disposed between the panels; the front panel carries two arrays of coplanar sustain electrodes which are coated with a dielectric layer providing the memory effect; each electrode of one of the arrays forms a pair with an electrode of the other array; the rear panel carries an array of address electrodes which are oriented perpendicularly to the sustain electrodes.

The image display system described in the document US 2002/0030645 therefore comprises means for generating the voltage pulses between the display electrodes, in particular a sustain generator that supplies the coplanar electrode pairs.

Such a driving method applied to such a display allows discharges to be triggered between the sustain electrodes of each pair, even when there is a wide gap separating them, without having to increase the voltage of the sustain pulses; thanks—especially to greatly extended discharges being obtained between these electrodes, such a driving method allows the luminous efficiency of plasma displays with coplanar sustain electrodes to be very significantly improved.

Applying the same sustain voltage pulses between the electrodes of each pair of the display initiates discharges simultaneously in all the pre-activated regions of the display and requires a sustain generator capable of supplying the sum of the currents of all these simultaneous discharges; the sustain generator components need to be sized to generate very high instantaneous currents; this requirement is all the more demanding the higher the number of discharge regions, which is the case for display screens having large dimensions and/or a high resolution.

Document US 4 316 123—IBM—describes a solution to this problem: instead of applying the sustain voltage pulses to all the electrode pairs of the display simultaneously, these pulses are applied in stages so as to trigger the sustain discharges in stages; the maximum instantaneous currents drawn from the sustain generator by the display are thus significantly reduced, which allows less costly generators to be employed.

### 3/SUMMARY OF THE INVENTION

An objective of the invention is to propose another solution to this problem, in the case where a driving method such as that described in the document US 2002/0030645 is used.

For this purpose, the subject of the invention is a method for driving a plasma screen for displaying images comprising discharge regions each located at an intersection of a pair of sustain electrodes and an address electrode, the said method comprising a succession of image frames or subframes which each comprise a sustain phase of the discharge regions which itself comprises the application of sustain voltage pulses V_{S} between the electrodes of each pair, and, during each sustain pulse, the application of trigger voltage pulses V_{M} to groups of discharge regions of the display, the sustain pulses being inadequate on their own for initiating discharges between the electrodes of the pairs, and the trigger pulses being designed to trigger these discharges in combination with the sustain pulses, characterized in that the trigger pulses are applied successively and not simultaneously to the various groups of discharge regions during the period of each sustain pulse.

In practice, each trigger pulse causes a potential difference V_{M} between one of the electrodes of each pair from the regions of a group and each address electrode from the regions of this group; the pulse can be obtained either by applying it directly to the address electrodes, or by superimposing complementary pulses of opposite sign onto the sustain pulses for each electrode of the sustain pairs while keeping the potential of the address electrodes constant.

When the trigger pulse is directly applied to the address electrodes, each group of discharge regions corresponds to a group of address electrodes or display columns, to which are simultaneously applied the same trigger pulse; the address or column electrodes are thus divided into various groups and, according to the invention, during the period of each sustain pulse, a trigger pulse is successively applied to the various groups of address electrodes.

According to the invention, the fact that each group of discharge regions receives its own trigger pulse in succession leads to the sustain discharges being initiated in stages between these various groups during each sustain pulse: the total instantaneous current drawn by the discharges is thus significantly reduced which allows less costly, and maybe smaller, sustain generators to be used.

In order to obtain stable discharges in the display and to optimize the luminous efficiency, the duration τ_{M} of the trigger pulses should be shorter than the duration τ_{S}/2 of the sustain pulses.

Preferably, in order to optimize the driving method of the invention, during the period of each sustain pulse, the trigger pulses are applied to the various groups of discharge regions in stages of uniform duration.

Preferably, if δt is the interval between two successive trigger pulse applications, and if σ_{1/2} is the width at half-height of the average curve of the current intensity of the discharges between the electrodes of the pairs as a function of time, δt is chosen such that δt ≧σ_{1/2}.

The time delay between the discharges in the various groups will then be long enough to allow the total instantaneous current of the discharges to be divided by a factor corresponding virtually to the number of discharge region groups.

Preferably, for each sustain pulse which comprises an approximately constant voltage plateau V_{S}, between a voltage rising edge and a voltage falling edge, the interval of time τ_{R} that separates the beginning of the said plateau and the first application of a trigger pulse is less than 100 ns. The reason for this is that in order to best guarantee the stability of the discharges, the distributed sequences of triggers should be started right from the beginning of the sustain pulse plateau.

Preferably, prior to each sustain phase, each frame or subframe also comprises an address phase for selectively activating discharge regions of the display, and the trigger pulses are able to trigger the discharges in combination with the sustain pulses solely in the pre-activated discharge regions.

Preferably, prior to each address phase, each frame or subframe further comprises a reset phase for the discharge regions. This reset phase conventionally comprises a charge equalization or “priming” operation and a charge erase operation.

### 4/ BRIEF DESCRIPTION OF THE DRAWINGS

The invention will be better understood upon reading the description that follows, presented as a non-limiting example and with reference to the appended figures, in which:

FIGS. 1 and 2 illustrate a plasma display to which the invention applies;

FIG. 3 shows timing diagrams of voltage signals applied to the display electrodes, in one embodiment of the invention;

FIG. 4A shows a sustain voltage pulse V_{S} applied between the coplanar electrodes of a discharge region and a trigger pulse for the discharge between these electrodes applied between one of these electrodes and the address electrode crossing this region;

FIG. 4B shows the discharge current flowing between the coplanar electrodes in arbitrary units (a.u.).

FIGS. 5A and 5B show the same sustain voltage pulse V_{S} and, respectively, a first trigger pulse for a first group of display address electrodes and a last trigger pulse for a last group of display address electrodes which is delayed relative to the others according to the invention.

FIG. 6 shows a variant to the timing diagrams in FIG. 3 relating to the sustain phase, for obtaining the trigger pulses.

FIG. 7 shows the maximum current intensity that the plasma display sustain generator needs to be able to generate as a function of the ratio δt/τ_{1/2}, where δt is the interval between two successive applications of trigger pulses, and where σ_{1/2} is the width at half-height of the average curve of the sustain discharge current intensity as a function of time, in the case where there are 27 discharge region groups, and where I₁ is the current required for widely spaced out trigger pulses (δt >>σ_{1/2}).

The figures showing timing diagrams do not take into account the true value scale in order that certain details will be more clearly visible than if the true proportions had been respected.

### 5/ PREFERRED EMBODIMENTS

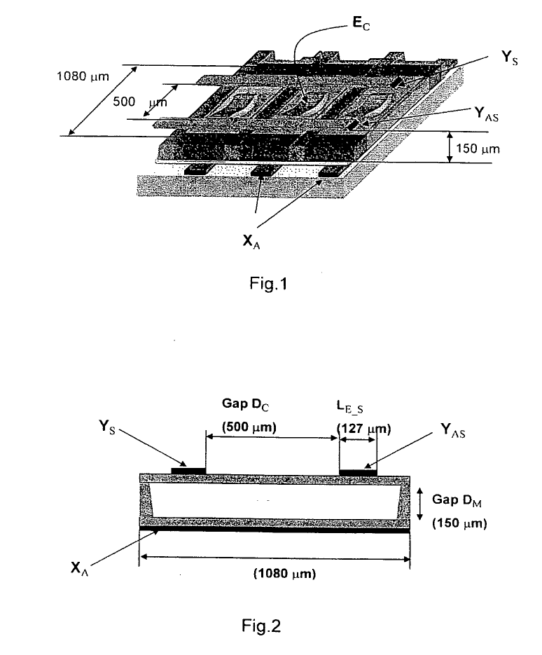

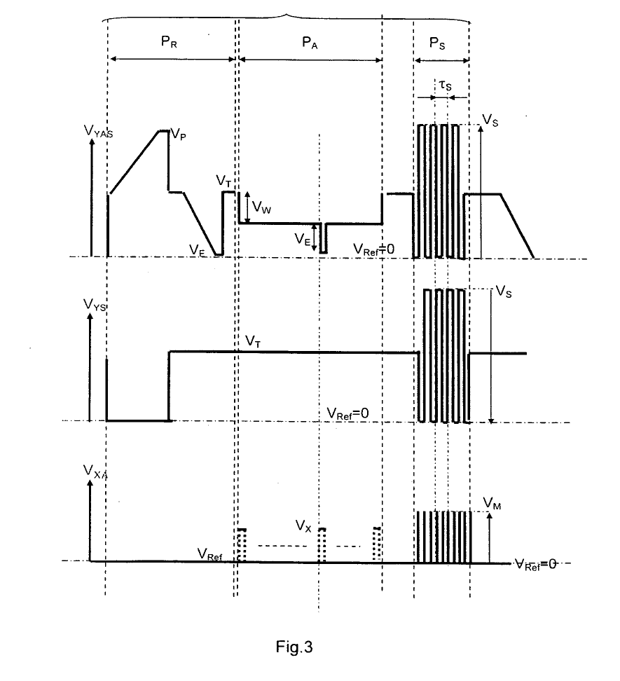

With reference to FIGS. 1 and 2, the plasma display, to which the driving method according to the invention will be applied, comprises two flat panels, one front and the other rear, creating a space between them that is filled with discharge gas, here of thickness 150 μm; the front panel carries two coplanar sustain electrode arrays, which are coated with a dielectric layer (not shown); each electrode Y_{S} of one of the.arrays forms a pair with an electrode Y_{AS} of the other array; the rear panel carries an array of address electrodes X_{A}, which are oriented perpendicularly to the sustain electrodes; in between the panels there is a network of barrier ribs that partition the space between the panels into discharge regions; there is a barrier rib between each sustain electrode pair; there is also a barrier rib in between each address electrode; the boundaries of each cell or discharge region of the display are thus defined by the panels and by the barrier ribs.

The distance separating the coplanar electrodes of any given pair, or gap D_{C}, is greater than the distance separating these electrodes from the address electrode at their crossing point; thus, the coplanar gap D_{C} here is 500 μm, whereas the thickness of the discharge gas or matrix gap D_{M} is 150 μm.

The width of the coplanar sustain electrodes L_{E}_{_{—}}_{S} here is only about 127 μm, whereas in general it is much greater in coplanar displays without matrix triggering in order to create therein a discharge expansion region over the width of these electrodes.

The rear panel of the display and the side faces of the barrier ribs are coated with phosphors which, when excited by the ultraviolet radiation from the discharges, emit the different primary colours of the images to be displayed; FIG. 1 shows three cells of different colours, red, green and blue, which form one pixel of the display.

Here, the distance between two adjacent rows of cells or two pairs of electrodes is 1080 μm.

All the numerical values are given above by way of an example and in no way limit the scope of the invention.

As will be seen hereinafter, one of the electrodes of each pair, Y_{AS}, is also used for addressing.

In order to display an image on the plasma display in operation, a succession of scans, or sometimes subscans, of the discharge regions to be activated or not are performed in the conventional way; with reference to FIG. 3, each scan or subscan comprises the following successive steps:
a discharge region reset step P_{R}, here comprising a charge equalization operation called “priming” and a charge erase operation; these operations are conventionally achieved by applying linear voltage ramp signals;
a selective address step P_{A} whose aim is to deposit electrical charges onto the portion of dielectric layer in the discharge regions to be activated, by applying at least one voltage pulse between the address electrodes Y_{AS}, X_{A} crossing each other within these regions; this deposition of charge in the discharge regions corresponds to the activation of these discharge regions;
then, a non-selective sustain step P_{S} during which a succession of voltage pulses V_{S} are applied between the coplanar electrodes Y_{S}, Y_{AS} of the sustain pairs and a succession of trigger pulses V_{M} between the electrodes Y_{AS} of the front panel and the address electrodes X_{A} of the rear panel, so as to initiate a succession of luminous discharges E_{C} solely in the discharge regions which are situated between these coplanar electrodes and which have been pre-activated.

FIG. 3 shows three timing diagrams of voltage pulses: that applied to the sustain and address electrodes Y_{AS}, that applied to the sustain-only electrodes Y_{S} and that applied to the address electrodes X_{A} which cross the sustain electrodes Y_{AS}, Y_{S} within each cell. These timing diagrams show a series of successive phases all belonging to the same scan or subscan cycle of the plasma display.

The rest of the description of the invention presents results obtained with a plasma display as described above which is filled with an Ne/4% Xe gas mixture at a pressure of 0.6×10⁵ Pa, and whose coplanar electrodes are supplied by a sustain generator delivering AC sustain pulses at a frequency of 150 kHz.

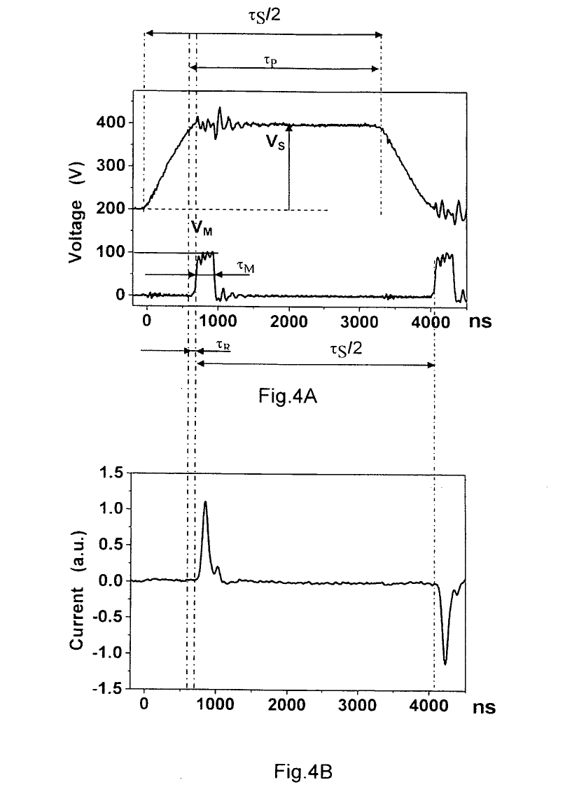

The sustain frequency of 150 kHz corresponds to a half-period τ_{S}/2 of 3333 ns which represents the maximum plateau duration for the sustain pulses, if the voltage rise and fall times are very short and if there is no intermediate voltage plateau in between. In practice, it can be clearly seen in FIG. 4A that the duration τ_{P} of this plateau is less than the half-period τ_{S}/2.

The address electrodes X_{A} or columns are supplied by an address pulse V_{X} generator, or by a trigger pulse V_{M} generator, via column drivers that allow each address electrode to be connected or not to one or the other of these generators; here, these column drivers are grouped in units of 92 drivers, so that, for 2592 columns, in other words 2592/3=864 pixels per row, there are 27 units across the whole width of the display.

Taking V_{S}=200 V and V_{M}=100 V as shown in FIG. 4A, coplanar discharges are obtained whose current is shown in FIG. 4B in arbitrary units; according to the invention, the voltage V_{S} is chosen to be lower than the minimum sustain voltage V_{S-min} that would allow coplanar discharges to be obtained with V_{M}=0 V. Thus, for V_{S}=200 V and V_{M}=0 V, no coplanar discharge would be obtained.

Integrating the voltage rise and fall times, the duration of a sustain pulse corresponds to a sustain half-period τ_{S}/2=3333 ns; the duration of a trigger pulse here is τ_{M} which is much smaller than τ_{S}/2 and here is equal to around 600 ns; τ_{M} should be long enough to trigger the coplanar discharges effectively and short enough to obtain a good luminous efficiency; in practice, τ_{M} is generally less than 1 μs.

The trigger pulse characteristics, namely their amplitude, their duration and the timing of their application with respect to the timing of the application of a sustain pulse, are optimally chosen with respect to the characteristics of the discharges regarding, in particular, their efficiency and their luminance; this optimization can readily be achieved by those skilled in the art.

Having fixed the coplanar potential V_{S} below the minimum sustain potential V_{S-min}, and having fixed the amplitude and the duration of the trigger pulses V_{M} so as to obtain a stable operation for all of the display cells, the invention consists of applying these trigger pulses in stages, over the duration of a sustain half-period, to all of the address or column electrodes of the display.

According to the invention:
the same trigger pulses are applied simultaneously to all the address electrodes of a particular group corresponding to the same unit of drivers; each group therefore comprises 96 column electrodes;
from one group of address electrodes to another, the trigger pulses are shifted by a non-zero time interval which is less than the sustain half-period so that each address electrode receives a trigger pulse during each sustain pulse;
the trigger pulse shifts of the various groups are staggered over time such that the trigger pulses of one group never coincide with the trigger pulses of another group; preferably, the pulses are distributed uniformly over time and the time delay between two successive groups is then denoted δt.

Such a pulse distribution scheme according to the invention does not imply that the trigger pulses of one group of electrodes are ended when the trigger pulses of the next group begin, which means that the delay between two successive groups δt may be much smaller than the duration of the trigger pulses τ_{M}.

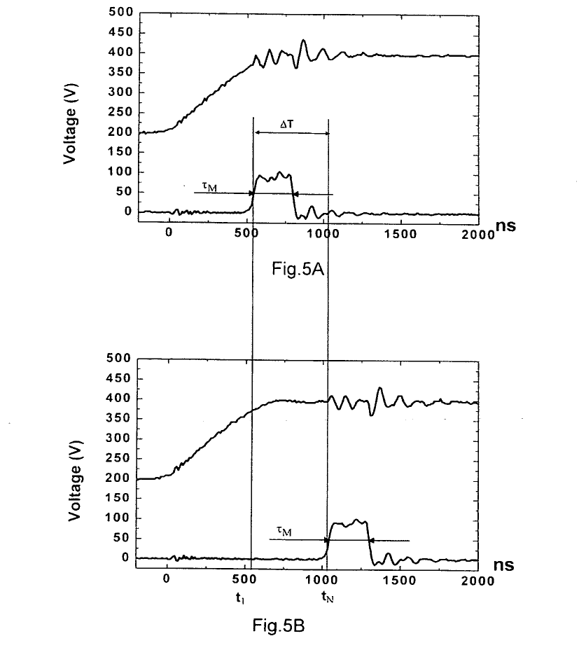

According to the invention and as illustrated in FIGS. 5A and 5B, if ΔT is the interval of time between the time t₁ when the first trigger pulse is applied and the time t_{N} when the N^{th} and last trigger pulse is applied (ΔT=t_{N}−t₁) during one sustain pulse, the N trigger pulses, applied in stages over the duration of the sustain pulse, are applied over the N=27 column driver units with a delay between two consecutive pulses of δt=ΔT/N as follows:

1. driver 1—pulse applied at t₁=t,

2. driver 2—pulse applied at t₂=t+δt,

3. driver 3—pulse applied at t₃=t+2δt,

4. . . . ,

5. driver i—pulse applied at tᵢ=t+(i−1) δt,

6. driver 27—pulse applied at t₂₇=t+26δt.

The number of trigger discharges distributed over time and separated by δt will therefore be N=ΔT/δt.

Thanks to this distribution of the trigger pulses over time and between the various groups of columns, the maximum instataneous current that must be delivered by the display sustain generator is very significantly reduced, which allows its cost and size to be reduced.

The maximum instataneous current obtained by distribution of the pulses depends on the value of the delay δt between two successive pulses relative to the duration of the discharge current as shown in FIG. 7. Taking I₁=1 (normalized) the maximum intensity of the current in the discharges triggered by the simultaneous application of a trigger pulse via the 92 column drivers of one particular unit, and σ_{1/2} its width at half-height, the maximum current that the display sustain generator must deliver is in the range between:

1. I_{N}=N×I₁ in the case of the prior art where the pulses are applied to all the units simultaneously (δt=0), and

2. I≅1.2×I₁ in the case of a delay δt equal to the width at half-height, in other words δt=σ_{1/2}.

As an example, for a delay δt=0.2×σ_{1/2}, the maximum instataneous current of the whole set of discharges is I≅5.4×I₁, which means a reduction by a factor 27/5.4=5 in the current that must be supplied by the display sustain generator thanks to the invention.

The maximum instataneous current of the whole set of discharges is divided exactly by the number N of units I=I_{N}/N=I₁ if the delay between two successive trigger pulses is greater than the width at half-height of the discharge current, in other words δt>>σ_{1/2}.

Preferably, with reference to FIG. 4A, at each sustain pulse, the distributed series of trigger pulses is initiated as soon as possible; preferably, the interval of time T_{R} which separates the beginning of a sustain pulse plateau and the first application of a trigger pulse is less than 100 ns.

The practical application of the invention must also take into account, on the one hand, the maximum possible interval ΔT between the first and the last pulse during the sustain half-period and, on the other hand, the frequency of the clock that controls the column drivers.

The interval ΔT between the first and the last trigger pulses applied during the same sustain pulse is clearly less than the duration of this sustain pulse; the maximum admissible value of the interval ΔT is conditioned by the necessity for obtaining stable triggered discharges between the coplanar sustain electrodes, even when they are triggered by the most delayed trigger pulses towards the end of the sustain pulse plateau. For example, for a half-height width σ_{1/2} of 100 ns, a delay time δt=σ_{1/2} leads to an interval ΔT=σ_{1/2}×N=100×27=2700 ns. It should therefore be ensured that the trigger pulse that is delayed by 2700 ns relative the first trigger pulse does indeed trigger stable sustain discharges. If this is the case, this advantageous distribution of the pulses allows the total current that needs to be supplied by the sustain generator to be reduced by a factor of 27/1.2=22.5 with respect to the case of simultaneous application of the trigger pulses of the prior art, in other words without delays.

It has in fact been verified that the trigger pulse delays do not significantly affect the luminous efficiency of the discharges: approximately the same luminous efficiency for delays of 450 ns, 550 ns, 700 ns, 1100 ns and 1250 ns have been obtained.

In practice, the delay δt between the pulses applied to each column driver unit (96 columns) is controlled by a clock whose frequency corresponds to this delay. Thus, a delay δt of 100 ns requires a clock with a frequency of 10 MHz.

If the frequency of the sustain pulses is too high and does not allow the whole series of trigger pulses to be distributed over an interval of 2700 ns, the interval ΔT between the first and the last pulse should then be reduced. A reduction in this interval ΔT leads to a reduction in the delay δt between successive trigger pulses and, consequently, requires the frequency of the control clock to be increased. For example, a delay δt of 20 ns between successive pulses applied to each column driver unit requires a clock with a frequency of 50 MHz. In this situation, δt=20 ns, and for a half-height width of the current in a unit σ_{1/2}=100 ns, the interval over which the pulses are distributed is reduced to ΔT=δt×N=20×27=540 ns. As shown in FIG. 7, for δt=0.2×σ_{1/2}, the total current that the sustain generator needs to supply is reduced by a factor of 5.

An advantageous variant of the invention will now be described.

Owing to the fact that the discharges are not all triggered at the same moment within the cells relative to the beginning of the sustain pulse plateau, differences in luminance between the cells corresponding to various groups of columns may be observed.

In order to solve the problem posed by the differences in luminance between the mutually delayed discharges, the pulses can be advantageously triggered, in rotation, at different moments during the subframe as follows:

1. driver 1—pulse applied at t₁, then at t₂, then at t₃, . . . , t₂₇

2. driver 2—pulse applied at t₂, then at t₃, then at t₄, . . . , then at t₂₇, then at t₁

3. . . .

4. driver i—pulse applied at tᵢ, then at tᵢ₊₁, then at t₁₊₂, . . . , then at tᵢ₋₁

5. driver 27—pulse applied at t₂₇, then at t₁, then at t₂, . . . , t₂₆.

Thanks to this variable distribution of electrode groups between the various application times t₁, t₂, . . . , t_{N} of the trigger pulses during the same sustain pulse, the differences in luminance between the mutually delayed discharges can be compensated over several scans or subscans.

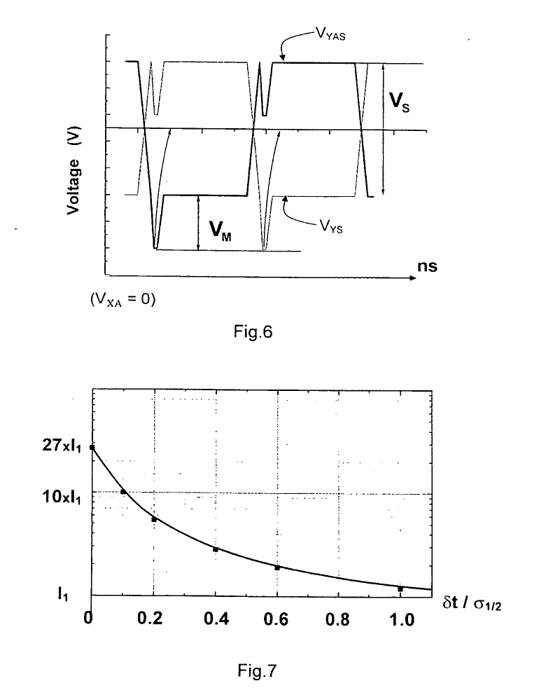

According to another variant of the invention, the trigger pulses can be obtained by keeping the potential of the address electrodes constant, while superimposing complementary pulses, of opposite sign, onto the sustain pulses for each electrode of the sustain pairs, as shown in FIG. 6.

Although the embodiments heretofore described are applicable to what are called “wide-gap” disscharges, the invention may be applied to all types of coplanar discharge, including discharges of the “narrow-gap” type, as long as they are capable of operating at a sustain potential below the extinction limit when they are controlled by matrix trigger pulses. It is advantageous that the geometry of the electrodes be designed for the purpose.

The main advantage afforded by the invention is a reduction in the cost of the electronics, in particular the sustain generator. As described previously, the distribution of the discharges controlled by time-shifted pulses allows the total current to be divided by the number of column driver units. Thus, the peak current supported by the row drivers and by the sustain generator can be reduced in the same proportion, and the size of the sustain generator is proportional to the peak current.

An implicit advantage of the invention is the increase of the discharge luminous efficiency; indeed, the superimposition of the trigger pulses V_{M} on the sustain potential V_{S} allows the power dissipated in the discharge to be reduced, thanks to the simultaneous reduction of the sustain potential V_{S} and the discharge current; whatever the position of the trigger pulse during the sustain pulse plateau, the current in the discharges controlled by the trigger pulse is less than that which would be obtained at the sustain minimum V_{S-min} in the absence of pulses: this is explained by the fact that, following the matrix ignition V_{M}, the coplanar discharge is maintained at a potential V_{S} lower than V_{S-min}.

1. Method for driving a plasma screen for displaying images comprising discharge regions each located at an intersection of a pair of sustain electrodes and an address electrode, the said method comprising a succession of image frames or subframes which each comprise a sustain phase of the discharge regions which itself comprises the application of sustain voltage pulses V_{S} between the electrodes of each pair, and, during each sustain pulse, the application of trigger voltage pulses V_{M} to groups of discharge regions of the display, the sustain pulses being inadequate on their own for initiating discharges between the electrodes of the pairs, and the trigger pulses being designed to trigger these discharges in combination with the sustain pulses, wherein the trigger pulses are applied successively and not simultaneously to the various groups of discharge regions during the period of each sustain pulse.

2. Method for driving according to claim 1, wherein the duration τ_{M} of the trigger pulses is shorter than the duration τ_{S}/2 of the sustain pulses.

3. Method for driving according to claim 1, wherein, during the period of each sustain pulse, the trigger pulses are applied to the various groups of discharge regions in stages of uniform duration.

4. Method for driving according to claim 3, if δt is the interval between two successive trigger pulse applications, and if σ_{1/2} is the width at half-height of the average curve of the current intensity of the discharges between the electrodes of the pairs as a function of time, δt is chosen such that δt ≧σ_{1/2}.

5. Method for driving according to claim 1, wherein, for each sustain pulse which comprises an approximately constant voltage plateau V_{S}, between a voltage rising edge and a voltage falling edge, the interval of time τ_{R} that separates the beginning of the said plateau and the first application of a trigger pulse is less than 100 ns.

6. Method for driving according to claim 1, wherein, prior to each sustain phase, each frame or subframe also comprises an address phase for selectively activating discharge regions of the display, and in that the trigger pulses are able to trigger the discharges in combination with the sustain pulses solely in the pre-activated discharge regions.

7. Method for driving according to claim 6 wherein, prior to each address phase, each frame or subframe further comprises a reset phase for the discharge regions.
